(19) United States
(12) Patent Application Publication
(10) Pub. No.: US 2025/0214075 A1
(43) Pub. Date: Jul. 3, 2025

(54) Method for Catalyst Recovery from Carbon Nanotubes and Use of Recycled Catalyst for CNT Production thereof

(71) Applicant: Indian Oil Corporation Limited, Mumbai (IN)

(72) Inventors: Narayanam SESHUBABU, Faridabad (IN); Sagar Pal KUMAR, Faridabad (IN); Bhanumurthy SAMALA, Faridabad (IN); Palvannan MOHANASUNDARAM, Faridabad (IN); Devotta IRUDAYARAJ, Faridabad (IN); Sankara Sri Venkata RAMAKUMAR, Faridabad (IN)

(73) Assignee: Indian Oil Corporation Limited, Mumbai, MH (IN)

(21) Appl. No.: 19/086,816

(22) Filed: Mar. 21, 2025

Related U.S. Application Data
(63) Continuation-in-part of application No. 18/133,311, filed on Apr. 11, 2023.

(30) Foreign Application Priority Data
Jun. 6, 2022 (IN) 202221032397
Mar. 23, 2024 (IN) 202423022783

(51) Int. Cl. B01J 38/66; B01J 23/889; B01J 23/94; B01J 37/00; B01J 37/02; B01J 37/03; B01J 37/08; B01J 37/18; B01J 38/52; C01B 32/162; C01B 32/17

(52) U.S. Cl. CPC B01J 38/66; B01J 23/8892; B01J 23/94; B01J 37/009; B01J 37/0236; B01J 37/038; B01J 37/08; B01J 37/18; B01J 38/52; C01B 32/162; C01B 32/17; C01B 2202/30; C01P 2002/82; C01P 2004/04; C01P 2006/11; C01P 2006/80

(57) ABSTRACT

This present invention relates in general to method for recovery of catalytic elements from raw carbon nanotubes (CNT). The present invention particularly relates to a method recovery of catalytic elements using a filtrate solution containing recovered catalytic elements from a CNT purification process. The present invention also relates to use of recovered/recycled catalytic elements for CNT production.

### CROSS-REFERENCE TO RELATED APPLICATIONS

The present patent application is a continuation in-part (CIP) of main U.S. patent application Ser. No. 18/133,311 of filing date Apr. 11, 2023 which claims priority from Indian patent Application No. 202221032397 filed on 6 Jun. 2022. Indian Patent of Addition Indian patent Application No. 202423022783 has been filed on 23 Mar. 2024. The present application comprises an improvement or a modification of the invention claimed in the specification of the main patent applied for in the U.S. patent application Ser. No. 18/133,311.

### FIELD OF THE INVENTION

This invention relates in general to method for recovery of catalytic elements from raw carbon nanotubes (CNT). The present invention particularly relates to a method of recovery of catalytic elements using a filtrate solution containing recovered catalytic elements from a CNT purification process. The present invention also relates to use of recovered/recycled catalytic elements for CNT production.

### BACKGROUND OF THE INVENTION

In general, CNT is produced on mass scale by catalytic vapour deposition process employing fixed bed or fluidized bed CVD reactors. The CNT production process requires the catalysts which encompassing the mixed transitional metals of Iron, Cobalt, Nickel, Manganese, Molybdenum finely dispersed or co-precipitated with carrier metal oxides such as Alumina, Magnesium oxide, silica or combination thereof. The resulted CNT is invariably associated with catalyst particle that are aided for CNT growth. The catalytic metals mainly lies either at the tip or base of the CNT tube depends on the catalyst type, growth conditions and reactor configuration. The catalyst type and preparation method affect the CNT morphology in terms of structural & electronic properties. Further, presence of catalytic metal impurities in the CNT will affect its electrical, electronic and mechanical properties. Therefore, in order to utilize the full potential of CNT in various applications, the produced CNT by the catalytic process eventually to be purified in order to remove the catalytic metallic impurities. In general, acid treatment for purification of CNT is widely reported in prior art to remove the metals, however these methods pose severe environmental challenges in terms of disposal of spent acids that are used for metal leaching. In addition, making of catalyst from extracted precious catalytic metals is cumbersome due to inefficient recovery process. Furthermore, due to scarcity and limited reserves of Cobalt, Nickel, there is push for recovery of these metals and hence to make recycled catalysts out of recovered metals.

In addition, catalytic CNT production process consumes the catalyst in significant quantity, and thus purification of CNT led to eliminate the metals by treating with acid solution. The metals thus extracted along with acid solution are difficult to recover in the form of catalyst and hence solution will be usually discarded. In order to make the process economically attractive, efforts are being made to reduce the CNT production cost by way of improving the CNT yield per gram catalyst and also recovering the catalytic elements from the raw CNT.

JP 6311391B2 disclosed the method for producing recycled substrate and method for producing catalyst substrate for carbon nanotube production, wherein substrate material is catalytic in nature and CNT grown over the substrate is recovered by peeling off the substrate surface followed by cleaning using ultrasonication and gas-liquid two fluid jet cleaning. However, this method has not disclosed the process of catalyst recovery from CNT and re-use of recovered catalyst for CNT production as described in the present invention.

JP6221290B2 disclosed the method of producing a reused substrate for carbon nanotube production, which includes an initialization step of supplying a metal salt to the side on which the catalyst layer is formed and removing a carbon component remaining on the base material, wherein the metal salt is an alkali metal salt or an alkaline earth metal salt. After the carbon nanotube growth, the spent catalyst layer is formed is washed with a metal salt solution and generated carbon nanotube has been peeled.

JP6287463B2 disclosed a method for producing a reusable base material using a used base material from which carbon nanotubes have been peeled from the surface, including an initialization step of cleaning the used substrate surface by applying a liquid containing fine bubbles to the surface of the used base material.

U.S. Pat. No. 8,852,547B2 disclosed a method for recovering a catalytic metal and carbon nanotubes from a supported catalyst is provided. In this method, the valence state of the catalytic metal associated with CNT which is not already in the positive state is getting oxidized to a positive state by contacting with a mild oxidizing agent under such conditions which does not destroy the carbon nanotube. The supported catalyst is simultaneously or subsequently contacted with an acid solution to dissolve the catalytic metal without dissolving the carbon nanotube. This method deals with noble metal catalysts supported in CNT using acid solution.

The prior art indicates that there are very limited reports available deals the re-use of the substrate used for CNT production process. In view of above, there is a need for catalyst elements recovery from as produced CNT and re-use/reutilization of recovered catalyst for CNT production process which enables the process cost effective.

### OBJECTIVES OF THE PRESENT INVENTION

The prime objective of the present invention is to provide a method for recovery of catalytic elements from raw carbon nanotubes (CNT).

The second objective of the present invention is to provide a method for recovery catalytic elements using a filtrate solution containing recovered catalytic elements from a CNT purification process.

The third objective of the present invention is to provide a use of recycled catalyst for CNT production process.

The fourth objective of the present invention is to provide a method to evaluate the recycled catalyst produced for the CNT production process, wherein catalytic activity in terms of CNT yield using recycled catalyst for CNT production achieved is greater than 95%.

### SUMMARY OF THE PRESENT INVENTION

This summary is provided to introduce a selection of concepts, in a simplified format, that are further described in the detailed description of the invention. This summary is neither intended to identify key or essential inventive concepts of the invention nor is it intended to determine the scope of the invention.

Method for recovery of the catalytic elements from the raw carbon nanotubes (CNT), wherein the said CNT is produced by the incipient catalytic fluidized process and a process for preparing the recycled catalyst using filtrate solution containing recovered catalytic elements from the former step of CNT purification process has been disclosed. The produced recycled catalysts showed similar catalytic activity as the fresh catalyst for the CNT production process. The resulted CNT is showed similar structural integrity as that is derived from fresh catalyst.

Method for recovery of mixed metal oxide catalyst that is embedded with raw Carbon nanotubes and utilization of thus produced recycled catalyst for CNT production has been disclosed with intent of making the process cost effective. The process of catalyst recovery from raw CNT and use of recycled catalyst for CNT production process has been disclosed in the following steps:
Step 1: CNT produced by mixed metal oxide catalyst comprising of mono or bi-metallic or multi-metallic combinations of Iron, Cobalt, Nickel, Manganese, Molybdenum, with carrier metal oxides such as Magnesia, Alumina, Silica or combination thereof in incipient fluidization process.
Step 2: Thus produced CNT of 93-95 wt % in step 1 is purified by non-mineral acid-based reagent solution which extracts catalytic metals into the reagent solution in the dissolved form in a continuous Agitated Nutsche Filter Dryer reactor, wherein raw CNT is purified up to >99 wt % carbon purity.
Step 3: The process of preparing the recycled catalyst from filtrate solution comprised the precipitation of filtrate solution obtained from step 2 with a suitable base solution at stipulated pH condition.
Step 4: The recycled catalyst produced from step 3 is evaluated for the CNT production process, wherein catalytic activity in terms of CNT yield using recycled catalyst for CNT production achieved >95%.

In one of the embodiments, the present invention provides a method for recovery of catalytic elements from raw carbon nanotubes (CNT), the method comprising;
a) obtaining the raw carbon nanotubes (CNT) embedded with the catalytic elements;
b) purifying the carbon nanotubes (CNT) by mixing the carbon nanotubes (CNT) with a reagent solution to form a carbon nanotubes (CNT) slurry;
c) heating the carbon nanotubes (CNT) slurry gradually from room temperature to a temperature of 120° C., while stirring;
d) filtering the carbon nanotubes (CNT) slurry to separate the carbon nanotubes (CNT) solids to obtain a liquid filtrate containing the catalytic elements;
e) precipitating the liquid filtrate containing the catalytic elements with a base reagent maintaining a pH in the range of 7 to 11 to obtain a precipitate;
f) filtering and drying the precipitate to obtain a dried catalyst;
g) calcinating the dried catalyst to recover the catalytic elements.

In another embodiment, the present invention provides a method for recovery of catalytic elements from raw carbon nanotubes (CNT), wherein the catalytic elements comprises mono or bi-metallic or multi-metallic combinations.

In another embodiment, the present invention provides a method for recovery of catalytic elements from raw carbon nanotubes (CNT), wherein the catalytic elements comprising mono or bi-metallic or multi-metallic comprises combinations of Iron, Cobalt, Nickel, Manganese, Molybdenum, with carrier metal oxides such as Magnesia, Alumina, Silica or combination thereof.

In another embodiment, the present invention provides a method for recovery of catalytic elements from raw carbon nanotubes (CNT), wherein the catalytic elements comprising mono or bi-metallic or multi-metallic comprises combinations of Fe-Ni, or Fe-Co, Fe-Mn,, Ni-Mn, Ni-Co, Co-Mn supported on Alumina, Magnesia, and silica or mixture of supports, or combination thereof.

In a preferred embodiment, the present invention provides a method for recovery of catalytic elements from raw carbon nanotubes (CNT), wherein the reagent solution is a non-mineral acid-based reagent solution.

In another embodiment, the present invention provides a method for recovery of catalytic elements from raw carbon nanotubes (CNT), wherein the concentration of the reagent solution is based on the metal content present in the raw carbon nanotubes (CNT).

In another embodiment, the present invention provides a method for recovery of catalytic elements from raw carbon nanotubes (CNT), wherein the reagents concentration is maintained up to 2 times to the metal content present in the raw carbon nanotubes (CNT).

In a preferred embodiment, the present invention provides a method for recovery of catalytic elements from raw carbon nanotubes (CNT), wherein the reagent concentration varies from 0.1 to 2 times to the metal content present in the raw carbon nanotubes (CNT).

In another embodiment, the present invention provides a method for recovery of catalytic elements from raw carbon nanotubes (CNT), wherein the reagent solution comprises ammonium or potassium persulphate reagent solution, or sodium salt of ethylene diamine tetracetate (EDTA) solution, or a combination of both.

In another embodiment, the present invention provides a method for recovery of catalytic elements from raw carbon nanotubes (CNT), wherein the raw carbon nanotubes (CNT) is obtained by a liquid or gaseous hydrocarbon feedstock, wherein hydrocarbon feedstock is derived from crude oil or its products, ranging from C1 to C15 hydrocarbons.

In another embodiment, the present invention provides a method for recovery of catalytic elements from raw carbon nanotubes (CNT), wherein the base reagent is selected from a hydroxide or a carbonate of ammonium, sodium, Magnesium or potassium.

In a preferred embodiment, the present invention provides a method for recovery of catalytic elements from raw carbon nanotubes (CNT), wherein the carbon nanotubes (CNT) slurry is heated for a period of 4-12 hours.

In a preferred embodiment, the present invention provides a method for recovery of catalytic elements from raw carbon nanotubes (CNT), wherein the pH maintained during precipitation process is in the range of 8 to 9.5.

In another embodiment, the present invention provides a method for recovery of catalytic elements from raw carbon nanotubes (CNT), wherein the precipitate obtained in step e) is dried at a temperature in a range of 80° C. to 120° C.

In a preferred embodiment, the present invention provides a method for recovery of catalytic elements from raw carbon nanotubes (CNT), wherein the precipitate obtained in step e) is dried for 12 hours.

In a preferred embodiment, the present invention provides a method for recovery of catalytic elements from raw carbon nanotubes (CNT), wherein the precipitate obtained in step e) of claim 1 is dried at a temperature of 100° C.

In another embodiment, the present invention provides a method for recovery of catalytic elements from raw carbon nanotubes (CNT), wherein the dried catalyst is calcined at a temperature in a range of 400° C. to 800° C.

In a preferred embodiment, the present invention provides a method for recovery of catalytic elements from raw carbon nanotubes (CNT), wherein the dried catalyst is calcined at a temperature of 500° C.

In a preferred embodiment, the present invention provides a method for recovery of catalytic elements from raw carbon nanotubes (CNT), wherein the dried catalyst is calcined for 5 hours. In another embodiment, the present invention provides a method for recovery of catalytic elements from raw carbon nanotubes (CNT), wherein the catalytic elements content in the raw carbon nanotubes (CNT) is from 3 to 15 wt %.

In another embodiment, the present invention provides a method for recovery of catalytic elements from raw carbon nanotubes (CNT), wherein the catalytic elements are reutilized for CNT production.

In another embodiment, the present invention provides a method for recovery of catalytic elements from raw carbon nanotubes (CNT), wherein the CNT yield reutilizing the catalytic elements is 50% with respect to a hydrocarbon feedstock conversion.

### BRIEF DESCRIPTION OF THE ACCOMPANYING DRAWINGS

These and other features, aspect, and advantages of the present invention will become better understood when the following detailed description is read with reference to the accompanying drawings in which like characters represent like parts throughout the drawings are explained in more detail with reference to the following drawings:

FIG. 1 illustrates Transmission Electron Microscopy (TEM) of CNT-Example 2

FIG. 2 High-resolution transmission electron microscopy (HRTEM) of CNT-Example 3

FIG. 3 TEM of CNT-Example 7

FIG. 4 TEM of CNT-Example 8

FIG. 5 Raman Spectra of CNT-Example 2

FIG. 6 Raman Spectra of CNT-Example 3

FIG. 7 Raman Spectra of CNT-Example 7

FIG. 8 Raman Spectra of CNT-Example 8

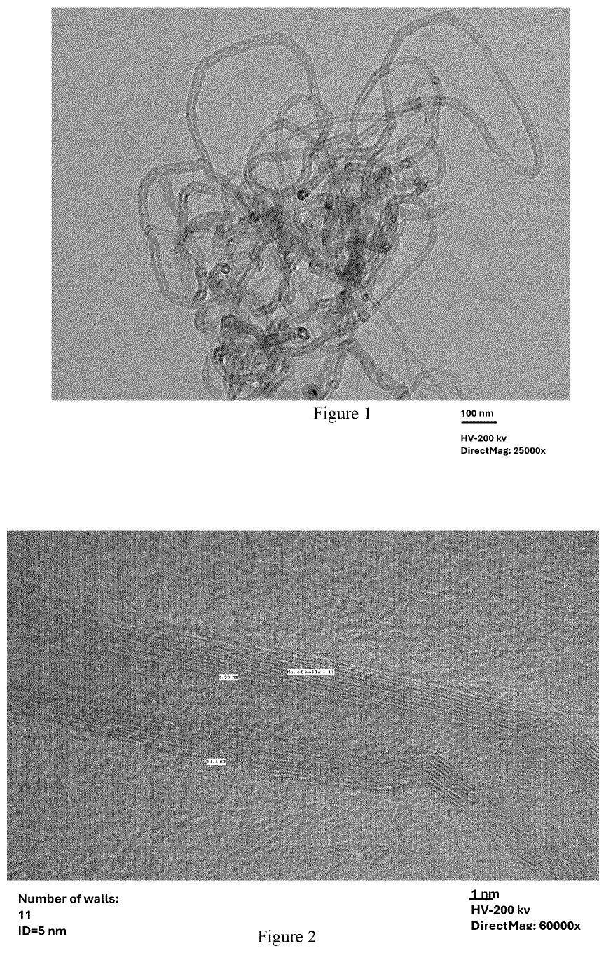

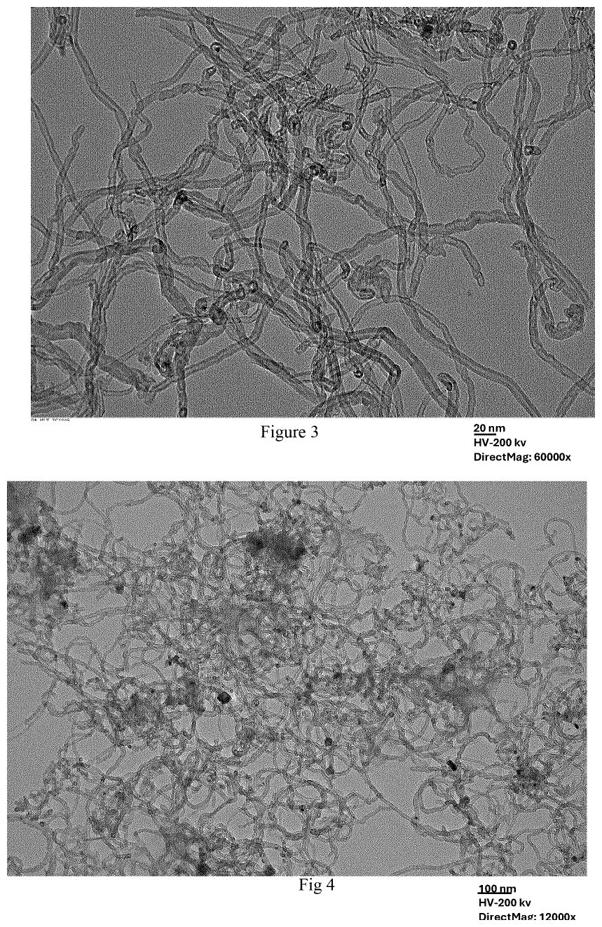

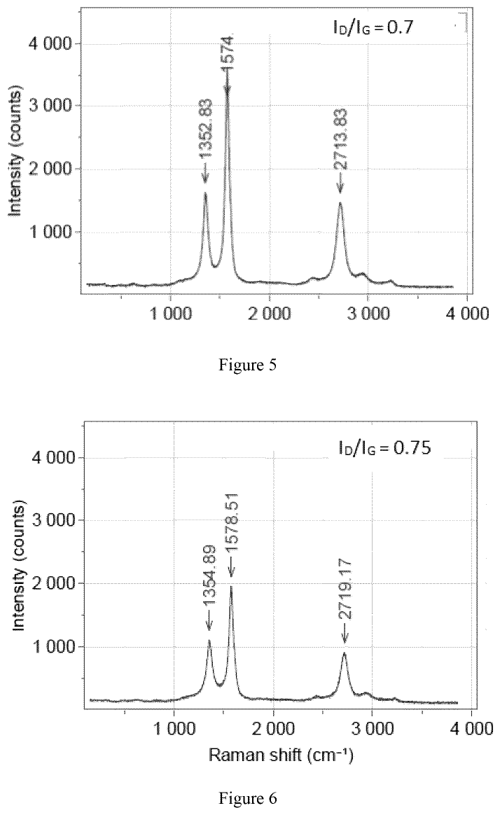

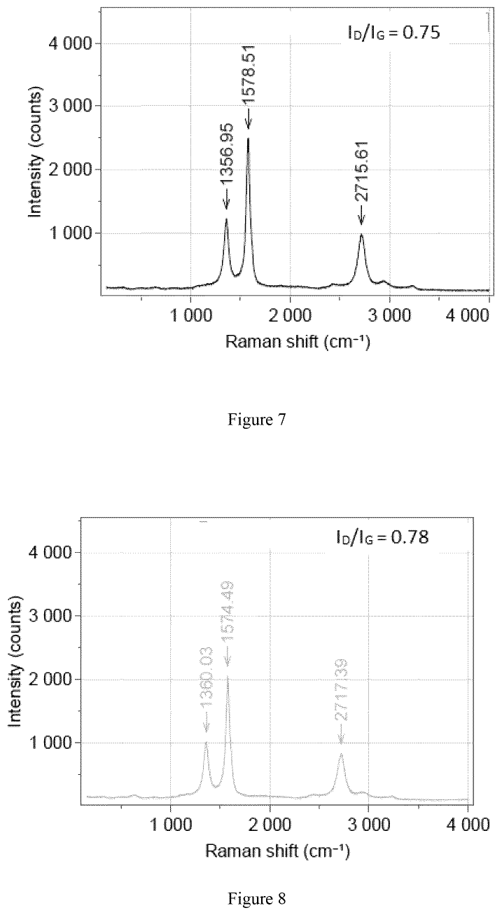

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

The present invention deals with method of recovery of the catalytic elements also referred as catalyst from raw carbon nanotubes and re-use the recycled/recovered catalyst/catalytic elements for CNT production. The present invention also discloses that the recycled/recovered catalyst enable the CNT production process with same structural integrity as like fresh catalyst. The present method discloses an alternative approach of purifying CNT without using mineral acid, and the disclosed purification process enables the recovery of the catalytic metals in the filtrate solution, thereby preparing the recycled catalyst using the filtrate solution of CNT purification step. The present invention deals with a non-mineral acid purification of carbon nonmaterial in aqueous solution and thus obtained filtrate solution of carbon nanotubes CNT purification process is utilized to the recover the recycled catalyst or catalytic elements. The catalytic activity of recycled catalyst prepared from the CNT purification filtrate shown nearly similar catalytic activity of fresh catalyst for the CNT production process while maintaining the same structural integrity of CNT.

Method for recovery of mixed metal oxide catalyst that is embedded with raw Carbon nanotubes and utilization of thus produced recycled catalyst for CNT production has been disclosed with intent of making the process is cost effective. The process of catalyst recovery from raw CNT and use of recycled catalyst for CNT production process has been disclosed in the following steps;
Step 1: CNT produced by mixed metal oxide catalyst comprising of mono or bi-metallic or multi-metallic combinations of Iron, Cobalt, Nickel, Manganese, Molybdenum, with carrier metal oxides such as Magnesia, Alumina, Silica or combination thereof in incipient fluidization process.
Step 2: Thus produced CNT of 93-95 wt % in step 1 is purified by non-mineral acid-based reagent solution which extracts catalytic metals/catalytic elements into the reagent solution in the dissolved form in a continuous Agitated Nutsche Filter Dryer reactor, wherein raw CNT is purified up to >99 wt % carbon purity.
Step 3: The process of preparing the recycled catalyst from filtrate solution comprised the precipitation of filtrate solution obtained from step 2 with a suitable base solution at stipulated pH condition.
Step 4: The recycled catalyst produced from step 3 is evaluated for the CNT production process, wherein catalytic activity in terms of CNT yield using recycled catalyst for CNT production achieved >95%.

In one of the embodiments, the present invention provides a method for recovery of catalytic elements from raw carbon nanotubes (CNT), the method comprising;
a) obtaining the raw carbon nanotubes (CNT) embedded with the catalytic elements;
b) purifying the carbon nanotubes (CNT) by mixing the carbon nanotubes (CNT) with a reagent solution to form a carbon nanotubes (CNT) slurry;
c) heating the carbon nanotubes (CNT) slurry gradually from room temperature to a temperature of 120° C., while stirring;
d) filtering the carbon nanotubes (CNT) slurry to separate the carbon nanotubes (CNT) solids to obtain a liquid filtrate containing the catalytic elements;
e) precipitating the liquid filtrate containing the catalytic elements with a base reagent maintaining a pH in the range of 7 to 11 to obtain a precipitate;
f) filtering and drying the precipitate to obtain a dried catalyst;
g) calcinating the dried catalyst to recover the catalytic elements.

In another embodiment, the present invention provides a method for recovery of catalytic elements from raw carbon nanotubes (CNT), wherein the catalytic elements comprises mono or bi-metallic or multi-metallic combinations.

In another embodiment, the present invention provides a method for recovery of catalytic elements from raw carbon nanotubes (CNT), wherein the catalytic elements comprising mono or bi-metallic or multi-metallic comprises combinations of Iron, Cobalt, Nickel, Manganese, Molybdenum, with carrier metal oxides such as Magnesia, Alumina, Silica or combination thereof.

In another embodiment, the present invention provides a method for recovery of catalytic elements from raw carbon nanotubes (CNT), wherein the catalytic elements comprising mono or bi-metallic or multi-metallic comprises combinations of Fe-Ni, or Fe-Co, Fe-Mn, Ni-Mn, Ni-Co, Co-Mn supported on Alumina, Magnesia, and silica or mixture of supports, or combination thereof.

In a preferred embodiment, the present invention provides a method for recovery of catalytic elements from raw carbon nanotubes (CNT), wherein the reagent solution is a non-mineral acid-based reagent solution.

In another embodiment, the present invention provides a method for recovery of catalytic elements from raw carbon nanotubes (CNT), wherein the concentration of the reagent solution is based on the metal content present in the raw carbon nanotubes (CNT).

In another embodiment, the present invention provides a method for recovery of catalytic elements from raw carbon nanotubes (CNT), wherein the reagents concentration is maintained up to 2 times to the metal content present in the raw carbon nanotubes (CNT).

In a preferred embodiment, the present invention provides a method for recovery of catalytic elements from raw carbon nanotubes (CNT), wherein the reagent concentration varies from 0.1 to 2 times to the metal content present in the raw carbon nanotubes (CNT).

In another embodiment, the present invention provides a method for recovery of catalytic elements from raw carbon nanotubes (CNT), wherein the reagent solution comprises ammonium or potassium persulphate reagent solution, or sodium salt of ethylene diamine tetracetate (EDTA) solution, or a combination of both.

In another embodiment, the present invention provides a method for recovery of catalytic elements from raw carbon nanotubes (CNT), wherein the raw carbon nanotubes (CNT) is obtained by a liquid or gaseous hydrocarbon feedstock, wherein hydrocarbon feedstock is derived from crude oil or its products such as hydrocarbons ranging from C1 to C15 comprising both gas and liquid streams.

In another embodiment, the present invention provides a method for recovery of catalytic elements from raw carbon nanotubes (CNT), wherein the base reagent is selected from a hydroxide or a carbonate of ammonium, sodium, Magnesium or potassium.

In a preferred embodiment, the present invention provides a method for recovery of catalytic elements from raw carbon nanotubes (CNT), wherein the carbon nanotubes (CNT) slurry is heated for a period of 4-12 hours.

In a preferred embodiment, the present invention provides a method for recovery of catalytic elements from raw carbon nanotubes (CNT), wherein the pH maintained during precipitation process is in the range of 8 to 9.5.

In another embodiment, the present invention provides a method for recovery of catalytic elements from raw carbon nanotubes (CNT), wherein the precipitate obtained in step e) is dried at a temperature in a range of 80° C. to 120° C.

In a preferred embodiment, the present invention provides a method for recovery of catalytic elements from raw carbon nanotubes (CNT), wherein the precipitate obtained in step e) is dried for 12 hours.

In a preferred embodiment, the present invention provides method for recovery of catalytic elements from raw carbon nanotubes (CNT), wherein the precipitate obtained in step e) is dried at a temperature of 100° C.

In another embodiment, the present invention provides a method for recovery of catalytic elements from raw carbon nanotubes (CNT), wherein the dried catalyst is calcined at a temperature in a range of 400° C. to 800° C.

In a preferred embodiment, the present invention provides a method for recovery of catalytic elements from raw carbon nanotubes (CNT), wherein the dried catalyst is calcined at a temperature of 500° C.

In a preferred embodiment, the present invention provides a method for recovery of catalytic elements from raw carbon nanotubes (CNT), wherein the dried catalyst is calcined for 5 hours.

In another embodiment, the present invention provides a method for recovery of catalytic elements from raw carbon nanotubes (CNT), wherein the catalytic elements content in the raw carbon nanotubes (CNT) is from 3 to 15 wt %.

In another embodiment, the present invention provides a method for recovery of catalytic elements from raw carbon nanotubes (CNT), wherein the catalytic elements are reutilized for CNT production.

In another embodiment, the present invention provides a method for recovery of catalytic elements from raw carbon nanotubes (CNT), wherein the CNT yield reutilizing the catalytic elements is 50% with respect to a hydrocarbon feedstock conversion.

A method of recovery of catalytic elements or metals from the raw CNT using non-mineral acid reagent approach, catalyst preparation using recovered metal solutions and re-use of the recovered catalyst for CNT production process is disclosed. The resulted re-cycle catalyst shown same physico-chemical characteristics and catalytic activity retained up to 95%. Raw CNT bearing the catalytic metals ≥15 wt % or lower which may be present at the tip or base of the CNT tip or embedded with edges or across the cross-section of CNT tubes or peripherals of the CNT is treated with ammonium or potassium persulphate reagent solution or sodium salt of ethylene diamine tetracetate (EDTA) solution or combination of both reagents at temperature ranging from ambient to 120° C., wherein the reagents concentration is maintained either equivalent or more up to 2 times to the metal concentrations present in the CNT. The said process involves the mixing of reagent solution with raw CNT bearing catalytic metals, thus formed slurry kept under stirring in a vessel which is electrically heated at temperature ranging from room temperature to 120° C. After stipulated stirring time, the slurry is transferred to filtration vessel, where CNT solids are separated from liquid. The liquid filtrate contains catalytic metals which are extracted from raw CNT during the purification process.

The liquid filtrate solution contains mixture of catalytic metals which are extracted from the raw CNT wherein the said catalytic metals comprising of transitional metals namely iron, Nickel, Cobalt, Manganese, Molybdenum or combination along with Magnesium. The extracted catalytic metal concentrations in the liquid reagent solution depend on the type of the catalyst & its composition is being used for the CNT production process. The liquid filtrate solution containing catalytic elements is further precipitated with a suitable base reagent to precipitate the metals under appropriate pH condition. The resultant solid catalyst precipitate is separated by filtration and then dried in a Hot air oven at 100° C. to remove the excess moisture. The dried catalyst sample is thermally treated at a temperature range of 400-800° C. to obtain the finished catalyst.

The resultant recycled catalyst is subsequently evaluated its activity for CNT production process using hydrocarbon feedstock in a continuous/semi-continuous reactor, wherein the catalytic activity of recycled catalyst is retained as high as fresh catalyst. The CNT yield with fresh catalyst is in the range of 50 to 60 wt % with respect to feed conversion, whereas the recycled catalyst provides the same CNT yield as like fresh catalyst within ±5%. It is notable to mention here that the morphology of CNT derived from recycled catalyst is also maintained the same as of fresh catalyst in terms of a number of walls, tube diameter, and other physical characteristics. Furthermore, it is also been studied that to achieve the CNT yield of fresh catalyst, the recycled catalyst may be make up to 1 to 5% with the fresh catalyst to compensate for the minor loss if any in catalyst activity of recycled catalyst.

The disclosed method of recycled catalyst for CNT production process paved the way to make the process more economically viable, as there will be no catalyst input cost is applicable notionally to produce the CNT.

### Embodiments

In one of the major embodiments, catalyst recovery from the raw CNT using non-mineral acid based reagent solution, wherein the reagent solution comprises the single or mixture of reagents.

In another embodiments, the reagent mixture is either ammonium or potassium persulphate with minor amounts of sodium salt of ethylene diamine or ammonium or potassium persulphate or sodium salt of ethylene diamine, wherein reagents are solubilised in water.

In other embodiments, concentration of reagent solution is chosen based on the metal content present in the raw CNT, wherein the reagent concentration varies from 0.1 to 2 times to the metal concentration.

In other embodiments, the raw CNT bearing total catalytic metals content varies from 85 to 97 wt %, wherein the metals comprising of Iron, Nickel, Cobalt, Manganese, Magnesium, Silicon, Aluminium in various proportions.

In yet other embodiments, metal content can be combination of bi-metallic or tri-metallic with combination of Fe-Ni, or Fe-Co, Fe-Mn,, Ni-Mn, Ni-Co, Co-Mn supported on Alumina, Magnesia, and silica or mixture of supports, or combination thereof.

In another embodiments, raw CNT is produced from the above said catalyst composition using liquid or gaseous hydrocarbon feedstock, wherein hydrocarbon feedstock is derived from crude oil or its products.

In other embodiments, the CNT produced from above process having carbon purity in the range of 85 to 97%, wherein catalytic metal contents varies from 3 to 15 wt %,

In other embodiments, raw CNT is treated with aforementioned reagent solution with stipulated concentration ratio based on the catalytic metals present in the raw CNT,

In other embodiments, above said purification treatment resulted in the filtrate solution by separating the solid CNT content, wherein filtrate solution is enriched with catalytic metals that are extracted from raw CNT, while purified CNT having carbon purity of >99.5 wt %.

In other embodiments, the metals enriched filtrate solution is co-precipitated or direct precipitated with suitable base solution without modifying the filtrate solution, wherein the base solution is selected from either hydroxide or carbonate of ammonium, sodium, Magnesium or potassium.

In other embodiments, pH maintained during precipitation process varies from 7 to 11, preferably in the range of 8 to 9.5, wherein catalytic metals will be precipitated in the form of hydroxides or carbonates depending on the type of counter ion base used for the precipitation process.

In other embodiments, the resulted precipitate mass is dried in hot air oven at the temperature range of 80 to 120 C. The oven dried catalyst is further calcined at the temperature range of 400 to 800 C.

In another embodiment, the finished recycled catalyst showed physico-chemical characteristics as like fresh catalyst in terms of total elemental composition variation of +/−5 wt % as determined by ICAP.

In another embodiment, the total hydrogen consumption of the catalyst is resulted same as fresh catalyst as determined by Temperature programmed reduction (TPR), wherein the hydrogen consumption for fresh catalyst is reported to be 12 to 14 mmol/gm while the hydrogen consumption for recycled catalyst shown as 11 to 13.5 mmol/gm.

In another embodiment, the catalytic activity of recycled catalyst for the CNT production process has been maintained merely same as with fresh catalyst, wherein the CNT yield of the fresh catalyst is reported in the range of 55 to 60 wt %, while CNT yield derived from recycled catalyst is reported in the range of 50 to 60 wt % on feed conversion basis without altering other process conditions. The carbon purity of CNT derived from recycled catalyst shows nearly 90 to 95 wt % while CNT derived from fresh catalyst shows in the range of 93 to 97 wt %.

In another embodiment, the quality of CNT is showing fairly similar key physico-chemical characteristics in terms of tube diameter, tube length, bulk density, peak intensity ratio of D to G band of Raman spectra, surface area.

### Examples

### Example 1

Pristine catalyst is prepared by Co-precipitation method, in which suitable quantities of metal precursors are mixed in water solution, the same solution is precipitated by using base solution as follows.

1 kg of cobalt nitrate hexa hydrate and 1.5 kg of Manganese nitrate tetrahydrate is dissolved in 1 litre of de-ionized water each separately in two different vessels. The solutions are mixed together in a separate vessel, which is termed as active precursor solution, A. In a separate vessel, 4 kg of Magnesium Nitrate Hexa Hydrate is dissolved in de-ionized water, which is termed as support ssolution, B. Solution A & B are mixed together and transferred to the vessel connected to dosing pump. On the other hand, IM ammonia solution is prepared by diluting 25 wt % ammonia solution with de-ionized water, which is termed as base solution, C. The catalyst precursor solutions (mixture of A&B) are precipitated with solution C by co-precipitation process in a water solution. Thereafter, the resultant slurry is aged for 6 hours and filtered to obtain the wet cake. The catalyst cake is dried in oven at 120° C. for 12 hours and then calcined at 600° C. for 6 hours. The finished catalyst is thus used for the CNT production process in a vertical fluidized reactor. The characterization of catalyst by ICAP reveals that metals concentration of the catalyst is measured as Cobalt-19.3 wt %, Mn-31.5 wt %, and Mg-35 wt %.

### Example 2

The catalyst produced in example 1 is evaluated for the CNT production process using naphtha feed. In a tubular reactor, 100 grams of catalyst produced in example 1 is loaded on the catalyst distribution plate. Further, reactor is electrically heated up to 650° C. in the presence of nitrogen gas. After attaining the desired temperature, the hydrogen gas is fed along with nitrogen carrier gas co-currently over the catalyst in order to reduce the catalyst. After completion of reduction step, petroleum naphtha feed of boiling range up to 150° C. is fed into the reactor over the catalyst along with nitrogen carrier gas. During the course of the process, CNT starts to grow over the catalyst for 4 hours. Further reactor is cooled off to ambient temperature under nitrogen flow to evacuate CNT from the reactor. The yield of CNT is recorded as 52% having carbon purity of nearly 95%, and bulk density of CNT is measured as ˜0.1 g/cc. Further, the produced CNT is characterized by laser-Raman spectroscopic analysis, Transmission Electron Microscopy (TEM), and Inductive Coupled Plasma (ICP).

### Example 3

1 kg of CNT produced from example 2 bearing metal concentrations of 5 wt % is treated with equimolar concentration of ammonium persulfate reagent (APS) solution with respect to residual metal concentration present in CNT. Accordingly, 250 grams of APS is dissolved in 10 liters of De-ionized water, and the solution is charged in a Agitated nutsche filter dryers (ANFD). Thereafter, 1 kg of raw CNT which is produced in Example 3 is loaded into the ANFD reactor containing reagent solution under constant stirring. The resultant reagent mixed CNT slurry is kept under stirring for 6-12 hours at a temperature of 80° C. After the stipulated reaction time, the reactor is cooled off and slurry is filtered under high vacuum to remove the excess water. The obtained CNT wet cake is further washed with water and dried in hot air oven at 120° C. for 12 hours. On the other hand, the filtrate solution is recovered from the process is preserved to prepare the recycled catalyst.

### Example 4: Purification of CNT using Chelating Agent Solution

1 kg of CNT produced from example 2 bearing metal concentrations of 5 wt % is treated with equimolar concentration of disodium ethylene diamine tetra acetate (EDTA) solution with respect to residual metal concentration present in CNT. Accordingly, 200 grams of EDTA is dissolved in 10 liters of De-ionized water, and the solution is charged in a Agitated nutsche filter dryers (ANFD). Thereafter, 1 kg of raw CNT which is produced in Example 3 is loaded into the ANFD reactor containing reagent solution under constant stirring. The resultant reagent mixed CNT slurry is kept under stirring for 18-24 hours at room temperature. After the stipulated reaction time, the reactor is cooled off and slurry is filtered under high vacuum to remove the excess water. The obtained CNT wet cake is further washed with water and dried in hot air oven at 120° C. for 12 hours. On the other hand, the filtrate solution is recovered from the purification process and is preserved to prepare the recycled catalyst.

### Example 5: Preparation of Recycled Catalyst using Filtrate Solution of Example 3

The filtrate solution collected from CNT purification process is transferred into the vessel which connected with dosing pump. In another vessel, 1 molar ammonium hydroxide solution is prepared by dissolving, wherein the base solution vessel also connected to the dosing pump. The filtrate solution is co-precipitate with ammonium hydroxide base solution simultaneously while maintaining pH of the precipitated solution at 9. The resultant precipitate is filtered and dried in hot air oven at 120 C for 12 hours followed by calcinations at 500 C for 5 hours. The produced recycled catalyst is analyzed by ICAP for the total metal content. The ICAP data reveals that metal profiling of recycled catalyst is closed to >95% of the fresh catalyst metal profiling.

### Example 6: Preparation of Recycled Catalyst using Filtrate Solution of Example 4

The filtrate solution collected from CNT purification process is transferred into the vessel which connected with dosing pump. In another vessel, 1 molar ammonium hydroxide solution is prepared by dissolving, wherein the base solution vessel also connected to the dosing pump. The filtrate solution is co-precipitate with ammonium hydroxide base solution simultaneously while maintaining pH of the precipitated solution at 9. The resultant precipitate is filtered and dried in hot air oven at 120 C for 12 hours followed by calcinations at 500 C for 5 hours. The produced recycled catalyst is analyzed by ICAP for the total metal content. The ICAP data reveals that metal profiling of recycled catalyst is closed to >95% of the fresh catalyst metal profiling.

### Example 7: Production of CNT using Recycled Catalyst of Example 5

The recycled catalyst (55 grams) is produced in example 3, is evaluated for the CNT production process using naphtha feedstock following the same procedure as in Example 2. The recycled catalyst is loaded in vertical fluidized bed reactor, wherein reactor is heated to temperature of 650 C under nitrogen atmosphere. After attaining the desired temperature, catalyst is reduced with hydrogen gas for 2 hours. Further, hydrogen gas is switched off and naphtha is fed into the reactor continuously for 8 hours, wherein naphtha vapour is getting decomposed on the recycled catalyst, as a result carbon tends to grow over the catalyst. At this juncture, naphtha feed is stopped and reactor is allowed to cool down to ambient temperature to evacuate the CNT product. The obtained CNT yield is 50% with respect to naphtha conversion which is nearly same yield as with the fresh catalyst. The resultant CNT obtained by recycled catalyst is characterized by Laser-Raman, TEM, and ICAP in order to verify the physico-chemical characteristics of CNT with respect to CNT derived from fresh catalyst.

### Example 8: Production of CNT using Recycled Catalyst of Example 6

The recycled catalyst (40 grams) is produced in example 3, is evaluated for the CNT production process using naphtha feedstock following the same procedure as in Example 2. The recycled catalyst is loaded in vertical fluidized bed reactor, wherein reactor is heated to temperature of 650 C under nitrogen atmosphere. After attaining the desired temperature, catalyst is reduced with hydrogen gas for 2 hours. Further, hydrogen gas is switched off and naphtha is fed into the reactor continuously for 8 hours, wherein naphtha vapour is getting decomposed on the recycled catalyst, as a result carbon tends to grow over the catalyst. At this juncture, naphtha feed is stopped and then reactor is allowed to cool down to ambient temperature to evacuate the CNT product. The obtained CNT yield is 40% with respect to naphtha conversion which is nearly same yield as with the fresh catalyst. The resultant CNT obtained by recycled catalyst is characterized by Laser-Raman, TEM, and ICAP in order to verify the physico-chemical characteristics of CNT with respect to CNT derived from fresh catalyst.

| | CNT | CNT | Raman | Number | OD/ID | | H2 |
|---|---|---|---|---|---|---|---|
| | Yield | Purity | Spectra | of walls | (TEM) | ICAP | consumption |
| Examples | (wt %) | (wt %) | (I_{D}/I_{G}) | (TEM) | (nm) | (wt %) | (mmol/gm) |
| 1 | | | | | | Co-19.3 | 12.5 |
| | | | | | | Mn-31.5 | |
| | | | | | | Mg-35 | |
| 2 | 55 | 95 | 0.75 | 10-20 | 30, 10 | Co-0.9 | N.D |
| | | | | | | Mn-1.5 | |
| | | | | | | Mg-1.8 | |
| 3 | — | 99.5 | 0.70 | 10-20 | 30, 10 | Co-0.3 | N.D |
| | | | | | | Mn-0.1 | |
| | | | | | | Mg-0.1 | |
| 4 | — | 98.7 | 0.70 | 10-20 | 30, 10 | Co-0.7 | N.D |
| | | | | | | Mn-0.1 | |
| | | | | | | Mg-0.1 | |
| 5 | | | | | | Co-18.5 | 12.1 |
| | | | | | | Mn-30.8 | |
| | | | | | | Mg-31.5 | |
| 6 | | | | | | Co-14.5 | 11.5 |
| | | | | | | Mn-28.6 | |
| | | | | | | Mg-29.2 | |
| 7 | 53 | 94.5 | 0.75 | 12-20 | 25, 10 | Co-0.9 | N.D |
| | | | | | | Mn-1.3 | |
| | | | | | | Mg-1.7 | |
| 8 | 50 | 93 | 0.78 | 12-20 | 25, 10 | Co-0.8 | N.D |
| | | | | | | Mn-1.4 | |
| | | | | | | Mg-1.9 | |

### Advantages of the Invention

Catalyst recovery from the raw CNT using non-acid purification step, wherein raw CNT is purified by reagent aqueous solution.
High purity carbon nanomaterial of 99.5 wt % achieved without structural damage to CNT. No oxygen functional groups were introduced on CNT, hence electrical properties of CNT well preserved.
The resulting filtrate from the CNT purification process is utilized to prepare the recycled catalyst by precipitation process.
Recycled catalyst has shown same catalytic activity for the CNT production without any significant changes in the structural integrity of CNT.

We claim:

1. A method for recovery of catalytic elements from raw carbon nanotubes (CNT), the method comprising;
a) obtaining the raw carbon nanotubes (CNT) embedded with the catalytic elements;
b) purifying the carbon nanotubes (CNT) by mixing the carbon nanotubes (CNT) with a reagent solution to form a carbon nanotubes (CNT) slurry;
c) heating the carbon nanotubes (CNT) slurry gradually from room temperature to a temperature of 120° C., while stirring;
d) filtering the carbon nanotubes (CNT) slurry to separate the carbon nanotubes (CNT) solids to obtain a liquid filtrate containing the catalytic elements;
e) precipitating the liquid filtrate containing the catalytic elements with a base reagent maintaining a pH in the range of 7 to 11 to obtain a precipitate;
f) filtering and drying the precipitate to obtain a dried catalyst; and
g) calcinating the dried catalyst to recover the catalytic elements.

2. The method as claimed in claim 1, wherein the catalytic elements comprises mono or bi-metallic or multi-metallic combinations.

3. The method as claimed in claim 1, wherein the catalytic elements comprising mono or bi-metallic or multi-metallic comprises combinations of Iron, Cobalt, Nickel, Manganese, Molybdenum, with carrier metal oxides such as Magnesia, Alumina, Silica or combination thereof.

4. The method as claimed in claim 1, wherein the catalytic elements comprising mono or bi-metallic or multi-metallic comprises combinations of Fe-Ni, or Fe-Co, Fe-Mn, Ni-Mn, Ni-Co, Co-Mn supported on Alumina, Magnesia, and silica or mixture of supports, or combination thereof.

5. The method as claimed in claim 1, wherein the reagent solution is a non-mineral acid based reagent solution.

6. The method as claimed in claim 1, wherein the concentration of the reagent solution is based on the metal content present in the raw carbon nanotubes (CNT).

7. The method as claimed in claim 1, wherein the reagent solution comprises ammonium or potassium persulphate reagent solution, or sodium salt of ethylene diamine tetracetate (EDTA) solution, or a combination of both.

8. The method as claimed in claim 1, wherein the base reagent is selected from a hydroxide or a carbonate of ammonium, sodium, Magnesium or potassium.

9. The method as claimed in claim 1, wherein the precipitate obtained in step e) is dried at a temperature in a range of 80° C. to 120° C.

10. The method as claimed in claim 1, wherein the dried catalyst is calcined at a temperature in a range of 400° C. to 800° C.

11. The method as claimed in claim 1, wherein the catalytic elements content in the raw carbon nanotubes (CNT) is 3 to 15 wt %.

12. The method as claimed in claim 1, wherein the catalytic elements are reutilized for CNT production.

13. The method as claimed in claim 12, wherein the CNT yield reutilizing the catalytic elements is 50% with respect to a hydrocarbon feedstock conversion.
